(19) United States
(12) Patent Application Publication
(10) Pub. No.: US 2016/0295459 A1
(43) Pub. Date: Oct. 6, 2016

(54) Method And Apparatus For Improved Load Balancing

(71) Applicant: Alcatel-Lucent USA Inc., Murray Hill, NJ (US)

(72) Inventor: Sidney L. Bryson, Plainfield, IL (US)

(73) Assignee: Alcatel-Lucent USA Inc., Murray Hill, NJ (US)

(21) Appl. No.: 14/672,661

(22) Filed: Mar. 30, 2015

(51) Int. Cl. H04W 28/08; H04W 72/12; H04W 72/04

(52) U.S. Cl. CPC H04W 28/08; H04W 72/0486; H04W 72/1252

(57) ABSTRACT

Various methods and devices are provided to address the need for improved network load balancing. In a first method, a suitability for providing forward link service to a mobile device is determined for each wireless resource of a plurality of wireless resources. Each suitability determination is based on a pilot strength associated with that wireless resource and a loading metric associated with that wireless resource. Also, the weighting of the pilot strength relative to the loading metric in the determination is diminished as a loading level of that wireless resource increases. A wireless resource of the plurality of wireless resources is selected to provide forward link service to the mobile device based on the suitability determinations.

### FIELD OF THE INVENTION

The present invention relates generally to communications and, in particular, to load balancing in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

In wireless communication systems today, the load balancing techniques used seek to maintain and enhance user throughput. They prioritize user signal strength for the selection of offloading candidates. Some existing solutions involve manually adjusting many parameters at each cell to attempt to optimize the spatial load balancing for each sector. Not only is this undesirable from a network operators perspective, but it is not a dynamic solution that is able to quickly respond to situations causing resource overload.

Thus, new solutions and techniques that can provide better network load balancing would meet a need and advance wireless communications generally.

### BRIEF DESCRIPTION OF THE DRAWINGS

FIG. 1 is a diagram depicting an example of spatial offloading in accordance with certain embodiments of the present invention.

FIG. 2 is a block diagram depiction of a network node in accordance with various embodiments of the present invention.

FIG. 3 is a logic flow diagram of functionality performed by a network node in accordance with various embodiments of the present invention.

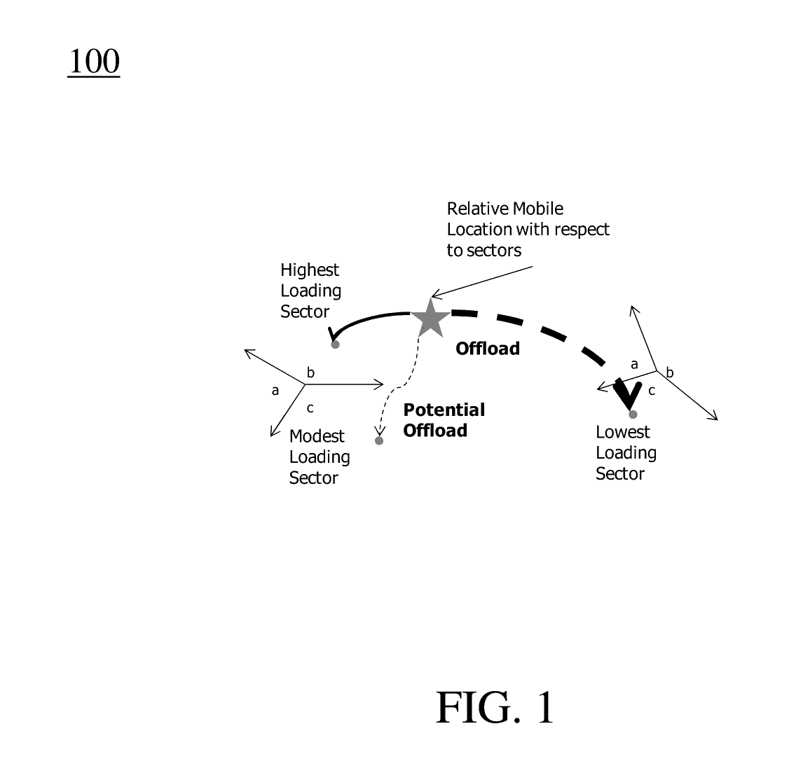

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to address the need for improved network load balancing. In a first method, a suitability for providing forward link service to a mobile device is determined for each wireless resource of a plurality of wireless resources. Each suitability determination is based on a pilot strength associated with that wireless resource and a loading metric associated with that wireless resource. Also, the weighting of the pilot strength relative to the loading metric in the determination is diminished as a loading level of that wireless resource increases. A wireless resource of the plurality of wireless resources is selected to provide forward link service to the mobile device based on the suitability determinations. An article of manufacture is also provided, the article comprising a non-transitory, processor-readable storage medium storing one or more software programs which when executed by one or more processors performs the steps of this first method.

Many embodiments are provided in which this first method is modified. For example, in many embodiments each wireless resource of the plurality of wireless resources comprises at least one wireless resource from the group of a carrier, a sector and a cell. In many embodiments, the plurality of wireless resources comprises wireless resources associated with active set members of the mobile device. Also, in many embodiments, the plurality of wireless resources comprises wireless resources for which pilot strength measurements have been received from the mobile device. Depending on the embodiment, the selected wireless resource is indicated to the mobile device via traffic channel assignment messaging.

A network node apparatus is also provided. The network node includes a network interface for communication with other network devices, a wireless transceiver, and a processing unit, communicatively coupled to the network interface and the wireless transceiver. The processing unit is configured to determine, for each wireless resource of a plurality of wireless resources, a suitability for providing forward link service to a mobile device. Each suitability determination is based on a pilot strength associated with that wireless resource and a loading metric associated with that wireless resource, and the weighting of the pilot strength relative to the loading metric in the determination is diminished as a loading level of that wireless resource increases. The processing unit is also configured to select, based on the suitability determinations, a wireless resource of the plurality of wireless resources to provide forward link service to the mobile device. Many embodiments are provided in which this network node apparatus is modified. Examples of such embodiments can be found described above with respect to the first method.

### DETAILED DESCRIPTION OF EMBODIMENTS

This proposal builds upon current network load balancing techniques in a non-obvious way by addressing the impact to the network verses the user as the first order problem constraint for load balancing. Previous methods maintain and enhance user throughput but have little impact on network capacity. They prioritize user signal strength for selection of offloading candidates, while this approach prioritizes network loading and relative loading to favor network performance more generally. This approach reclaims and harvests unused network capacity in a more substantial way, allowing operators to increase the efficiency of current cell deployments without changing parameters at individual cells. Some existing solutions involve manually adjusting many parameters at each cell to attempt to optimize the spatial load balancing for each sector. This approach provides the ability to dynamically adapt the load balancing to changing conditions in a much more tractable manner.

To provide a greater degree of detail in making and using various aspects of the present invention, a description of this load balancing approach in an EVDO CDMA system follows. FIG. 1 is referenced in an attempt to illustrate an offloading example, and a description of certain, quite specific, embodiments follow for the sake of example.

Current load balancing methods consider a minimum threshold for pilot strength and consider the pilot strength of each active set as an equal or heavily weighted input to the suitability of a sector-cell. The primary reason for this is to avoid offloading the forward link connection to a leg with low signal strength. However, the present approach, in effect, dynamically removes pilot strength as an input to suitability when the sector-cell is heavily loaded. It also allows the offloading to occur to the best sector-cell for the network. This approach to suitability determination is performed at the beginning of a connection and may be re-determined during the duration of the connection. Thus, as long as a mobile detects more than one sector-cell offloading can occur. In contrast, in the current state of the art, offloading only occurs when a mobile's additional sector-cells meet a pilot strength threshold. Simply lowering that threshold does not optimize the network offload or user experience, and it does not allow for a more normal selection when the network is not busy.

As shown in diagram 100 of FIG. 1, spatial offloading using the present approach may occur to a softer (same cell) neighbor or to a neighbor in another cell. In a heavily loaded situation, the approach will perform spatial offloading to an active set member with the lowest loading level, in most cases, to achieve the greatest gain in terms of relief from loading.

Each cell sector periodically reports its forward link loading to the network. For example, on a regular basis each BTS reports an indication of forward link, non-empty resources to its RNC. When a connection is made based on active set members (call legs, or links) reported by the mobile, the reported forward link loading and pilot strength (as reported by the mobile) is used as input in the suitability determination. Generally speaking, the weighting of pilot strength is greatly diminished in this suitability determination as the corresponding loading level increases. For example, the weighting of pilot strength may exponentially decrease with increases in loading level.

One way to express this suitability determination for the sector-cells for which a mobile is reporting pilot strength is as follows:

Suitability of sector-cell(i)=α*pilot-strength(i)+β*forward-loading-metric(i)

Where and β is operator controlled with a default of 1, and alpha approaches zero as an overall network loading metric increases. This will allow a dynamic bias towards using the forward loading metric as the overall network loading for that sector-cell increases. (Alpha and beta will also need to incorporate some scaling factors to account for the value ranges used to represent the forward loading metric and pilot strength. For example, the value range for pilot strength may be 0 to −20.)

For example, if a call has three legs (reverse link channels) then the algorithm should average the loading of each of the three sectors supporting the call and adjust the weighting of the pilot strength. If there is heavy loading for the system, then more relative weight should be put on using the forward loading metric (i.e., the weighting of the pilot strength in the formula is diminished). If the system average is light loading, then pilot strength will continue to have a roughly equal weight relative to the forward loading metric.

As mentioned above, this suitability determination is performed at the beginning of a connection and is re-determined during the connection as load balancing is needed. Thus, as long as a mobile detects more than one sector-cell, suitability-based selection and offloading can occur. The mobile is notified of the most suitable sector-cell from which it is to obtain its forward link by the traffic channel assignment messaging. The sector-cells detected by the mobile but which are not to be used are indicated in the traffic channel assignment messaging, thereby the most suitable sector-cell is indicated to the mobile.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts. In the examples, specific architectures, specific message names, specific message field values, specific messaging formats, and specific messaging sequences are all provided for the purpose of illustrating possible embodiments of the present invention and should not be interpreted as restricting or limiting the scope of the broader inventive concepts.

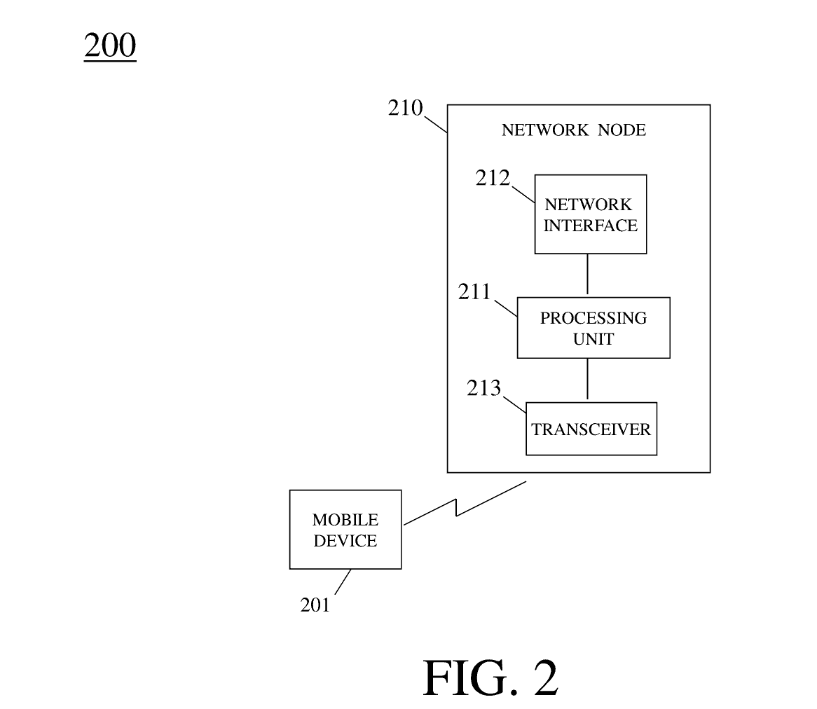

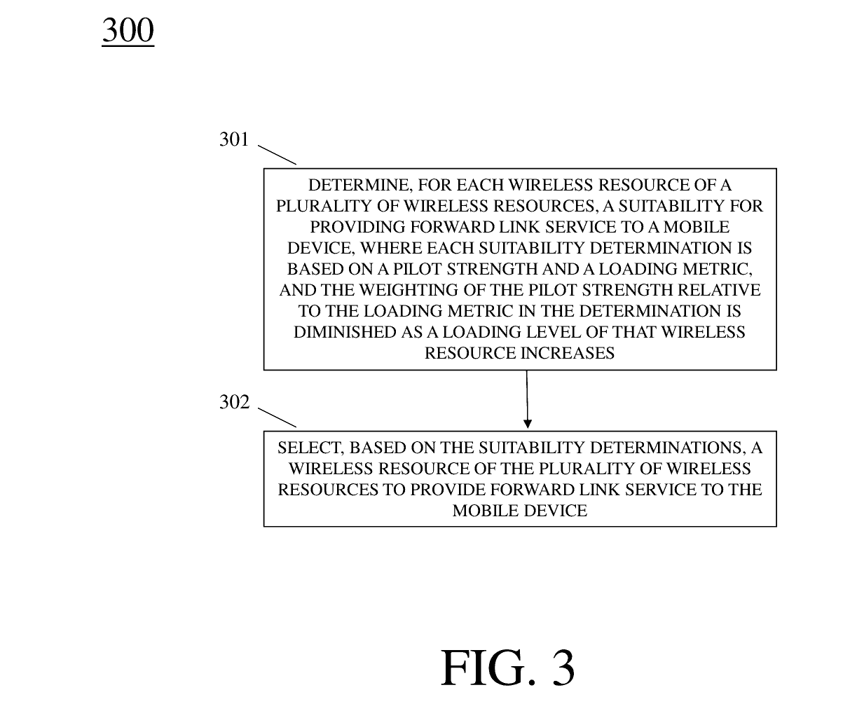

Having described certain embodiments in detail above, a review of the more general aspects common to many of the embodiments of the present invention can be understood with reference to FIGS. 2 and 3. Diagram 200 of FIG. 2 depicts network node 210 and mobile device 201 in accordance with various embodiments of the present invention. Network node 210 includes processing unit 211, network interface 212 and wireless transceiver 213.

Those skilled in the art will recognize that the network depiction in FIG. 2 does not show all of the components necessary to operate in a commercial communications system but only those components and logical entities particularly relevant to the description of embodiments herein. For example, network nodes are known to comprise processing units, network interfaces, and wireless transceivers. In general, such components are well-known. For example, processing units are known to comprise basic components such as, but neither limited to nor necessarily requiring, components from a group that includes microprocessors, microcontrollers, memory devices, application-specific integrated circuits (ASICs), and logic circuitry. Such components are typically adapted to implement algorithms or protocols that have been expressed using high-level design languages or descriptions, expressed using computer instructions, expressed using signaling flow diagrams, or expressed using logic flow diagrams.

Thus, given a high-level description, an algorithm, a logic flow, a messaging/signaling flow, or a protocol specification, those skilled in the art are aware of the many design and development techniques available to implement a processing unit that performs the given logic. Therefore, network node 210, for example, represents known devices that have been adapted, in accordance with the description herein, to implement multiple embodiments of the present invention. Furthermore, those skilled in the art will recognize that aspects of the present invention may be implemented in or across various physical components and none are necessarily limited to single platform implementations. For example, network node 210 may be implemented across one or more 802.11 network devices. As another example, network node 210 may be implemented across one or more radio network controllers (RNCs), across one or more base transceiver stations (BTSs), or across a combination of at least one RNC and at least one BTS.

In the example of FIG. 2, network node processing unit 211 determines, for each wireless resource of a plurality of wireless resources, a suitability for providing forward link service to mobile device 201. Each suitability determination is based on a pilot strength associated with that wireless resource and a loading metric associated with that wireless resource, and the weighting of the pilot strength relative to the loading metric in the determination is diminished as a loading level of that wireless resource increases. Processing unit 211 then selects, based on the suitability determinations, a wireless resource of the plurality of wireless resources to provide forward link service to mobile device 201. In most embodiments, the selected wireless resource is indicated to mobile device 201 via wireless transceiver 213. Depending on the embodiment, this indication may be performed via traffic channel assignment messaging.

Aspects of embodiments of the present invention can be understood with reference to FIG. 3. Diagram 300 of FIG. 3 is a logic flow diagram of functionality performed by a network node in accordance with various embodiments of the present invention. In the method depicted in diagram 300, a network node (perhaps one such as network node 210) determines (301) a suitability for providing forward link service to a mobile device for each wireless resource of a plurality of wireless resources. Each suitability determination is based on a pilot strength associated with that wireless resource and a loading metric associated with that wireless resource. Also, the weighting of the pilot strength relative to the loading metric in the determination is diminished as a loading level of that wireless resource increases. The network node then selects (302) a wireless resource of the plurality of wireless resources to provide forward link service to the mobile device based on the suitability determinations.

Many embodiments are provided in which the method depicted in diagram 300 is modified. For example, in many embodiments each wireless resource of the plurality of wireless resources comprises at least one wireless resource from the group of a carrier, a sector and a cell. In many embodiments, the plurality of wireless resources comprises wireless resources associated with active set members of the mobile device. Also, in many embodiments, the plurality of wireless resources comprises wireless resources for which pilot strength measurements have been received from the mobile device. Depending on the embodiment, the selected wireless resource is indicated to the mobile device via traffic channel assignment messaging.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms “a” or “an”, as used herein, are defined as one or more than one. The term “or”, as used herein, is defined as an inclusive or, which is satisfied by one or more than one of objects being present or true. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms “including” or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for improved load balancing, the method comprising:
determining, for each wireless resource of a plurality of wireless resources, a suitability for providing forward link service to a mobile device,
wherein each suitability determination is based on a pilot strength associated with that wireless resource and a loading metric associated with that wireless resource, and
wherein the weighting of the pilot strength relative to the loading metric in the determination is diminished as a loading level of that wireless resource increases;
selecting, based on the suitability determinations, a wireless resource of the plurality of wireless resources to provide forward link service to the mobile device.

2. The method as recited in claim 1, wherein each wireless resource of the plurality of wireless resources comprises at least one wireless resource from the group of a carrier, a sector and a cell.

3. The method as recited in claim 1, wherein the plurality of wireless resources comprises wireless resources associated with active set members of the mobile device.

4. The method as recited in claim 1, wherein the plurality of wireless resources comprises wireless resources for which pilot strength measurements have been received from the mobile device.

5. The method as recited in claim 1, further comprising
indicating the selected wireless resource to the mobile device.

6. The method as recited in claim 5, wherein indicating the selected wireless resource to the mobile device comprises
indicating the selected wireless resource via traffic channel assignment messaging.

7. A network node comprising:
a network interface for communication with other network devices;
a wireless transceiver; and
a processing unit, communicatively coupled to the network interface and the wireless transceiver, configured
to determine, for each wireless resource of a plurality of wireless resources, a suitability for providing forward link service to a mobile device, wherein each suitability determination is based on a pilot strength associated with that wireless resource and a loading metric associated with that wireless resource, wherein the weighting of the pilot strength relative to the loading metric in the determination is diminished as a loading level of that wireless resource increases, and
to select, based on the suitability determinations, a wireless resource of the plurality of wireless resources to provide forward link service to the mobile device.

8. The network node as recited in claim 7, wherein each wireless resource of the plurality of wireless resources comprises at least one wireless resource from the group of a carrier, a sector and a cell.

9. The network node as recited in claim 7, wherein the plurality of wireless resources comprises wireless resources associated with active set members of the mobile device.

10. The network node as recited in claim 7, wherein the plurality of wireless resources comprises wireless resources for which pilot strength measurements have been received from the mobile device.

11. The network node as recited in claim 7, wherein the processing unit is further configured
to indicate the selected wireless resource to the mobile device via the wireless transceiver.

12. The network node as recited in claim 11, wherein being configured to indicate the selected wireless resource to the mobile device comprises
being configured to indicate the selected wireless resource via traffic channel assignment messaging.
